(19) United States
(12) Patent Application Publication
(10) Pub. No.: US 2021/0241933 A1
(43) Pub. Date: Aug. 5, 2021

(54) APPARATUS AND METHOD FOR TREATING RADIOACTIVE EMISSION

(71) Applicant: PASMR TECHNOLOGY A PTY LTD, Brookvale (AU)

(72) Inventors: Peter Paalvast, Frenchs Forest (AU); Juergen Schmidt, Frenchs Forest (AU)

(21) Appl. No.: 17/051,833

(22) PCT Filed: Apr. 30, 2019
(86) PCT No.: PCT/AU2019/000051

§ 371 Date: Oct. 30, 2020

(30) Foreign Application Priority Data
Apr. 30, 2018 (AU) 20189011438

(51) Int. Cl. G21F 9/00; G21K 1/06; G21F 9/28

(52) U.S. Cl. CPC G21F 9/008; G21K 2201/067; G21F 9/28; G21K 1/067

(57) ABSTRACT

Apparatus for treating a source of radioactive emission, the apparatus including at least one reflecting means adapted to be in proximity to the source for receipt of the radioactive emission and to at least partially reflect received emission towards the source, thereby effecting reduction of the radioactive emission from the source.

### TECHNICAL FIELD

The present invention relates to an apparatus and method for treating radioactive emission, and in particular, the present invention relates to an apparatus and method for treating a source of radioactive emission by reflecting the radioactive emission onto at least a portion of the source.

### BACKGROUND OF THE INVENTION

The following references to and descriptions of prior proposals or products are not intended to be and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Currently, there are many powerful drivers for an increase worldwide in nuclear capacity. Debates for the increase in nuclear capacity are made easier by addressing valid concerns about nuclear fuel cycle safety and proper disposal and or handling of waste material and other by-products of the nuclear cycle. In particular, there is an increased energy supply need in the future, thus, if the concerns in relation to nuclear technology are addressed, this may then permit the widespread safe use of nuclear energy as a preferred choice in the ever increasing energy provision question. Further, the expanding research in fields of nuclear science and the application to nuclear medicine demands an increase in the number of research reactors in countries participating in and intending to benefit from such research.

The growth of the used fuel and radioactive waste treatment market and the storage and disposal market is linked to this demand-driven growth in the number of nuclear power reactors and research reactors planned to meet increasing global demand for energy and nuclear sciences.

However, one of the arguments against the increase of nuclear sites is the generation of radioactive waste, and further, the potential for nuclear disasters such as those witnessed in Chernobyl and Fukushima Daiichi, for example, that have caused significant adverse global impact through their catastrophic failures. Generally, radioactive waste is often just buried in remote radioactive landfills or in countries which have a conscience, medium-term controlled sites, with the hope that the toxic waste will hopefully stabilise over time. However, nuclear waste often remains active for a very long time in a site—over thousands of years with some twenty natural half-lives being necessary before the waste is actually be proven to be stable and safe. Furthermore, effective radioactive waste management is crucial in ensuring that levels of radiation are not causing harm to the environment and to all forms of plant and animal life.

The present invention seeks to provide a method and apparatus for treating radioactive emission which may ameliorate the foregoing shortcomings and disadvantages or which will at least provide a useful alternative.

### SUMMARY OF THE INVENTION

According to one aspect of the invention, there is provided herein an apparatus and a method for treating a source of radioactive emission.

The apparatus can include at least one reflecting means adapted or configured to be in proximity to the source for receipt of the radioactive emission and to at least partially reflect received emission towards the source, thereby effecting reduction of the radioactive emission from the source.

In one particular example, the reflecting means includes a wire array. In yet a further example, the reflecting means can include a plurality of wire arrays.

According to a further example, the wire of the wire array can include at least one coil of copper wire wrapped around a galvanised metal wire. In yet a further example, the galvanised metal wire is steel wire.

According to another example, the wire array includes spiralled wire formed in circles. It will be appreciated that the circles formed can be continuous, discrete, concentric, or in spirals.

In yet a further example, the wire array includes looped wire formed in zig-zags and or a serpentine formation. It will be appreciated that the wire array/s can include any form and number of wire/s in any combination of pattern, such as one or more spiralled wires, or one or more looped wires, or one or more wires stretched either longitudinally or transversely across other sets of wire/s.

It will be appreciated that the shape of the formation or type of the wire array can affect the type of radiation. Thus for example, circular wire arrays in the horizontal or vertical planes can affect alpha and beta rays, whereas serpentine formation with or without the copper wire can affect gamma rays. Thus, any one or more combinations of shapes/wire formations and types can be used to reflect various types of radiation, as required.

In yet another example, the apparatus includes a plurality of reflecting means. In another example, each of the plurality of reflecting means can include any one or a combination of wire arrays including looped wire formed in circles; and wire arrays including looped wire formed in serpentine or zig-zag arrays. In these examples, each type of wire formation can serve different purposes and types of radioactivity.

According to a further embodiment, the plurality of reflecting means is arranged to at least partially surround the source.

In yet another embodiment, the plurality of reflecting means is arranged within a container, the container being configured to hold the source therein. In yet a further example, the container holds the source at least partially in the centre, and one or more reflecting means are arranged within the container and around the sides of the container, thereby at least partially surrounding the source.

According to yet another example, the container has lead shielding. In yet a further example, the lead shielding is provided outside the container, on all sides of the container. Further, although the container can be of any size or shape, in one particular example, the container is a cube or rectangular prism which can accommodate the reflecting means and the source.

Accordingly, it will be appreciated by persons skilled in the art that the technology described herein can be included in small tea chest sized shapes; medium sized shipping container or single roomed shapes; or even larger warehouses aircraft hangers, and the like.

In yet a further example, the reflecting means is mounted on a panel. In one particular example, for low and intermediate level radiation, the panel or chest can be made from a piece or pieces of plywood and can hold the reflecting means thereon. It will be appreciated that higher level radiation materials may require less combustible substrates however any substrate which is an insulative material may be used to hold the array and it is not limited to wood or plywood.

According to another embodiment, the apparatus includes a plurality of panels, each of a plurality of the panels being placed internally around sides of the container, the source being placed centrally in the container such that the plurality of panels surround the source.

In yet a further example, the reflecting means includes an antenna, the antenna being configured to receive radiation and reflect radiation.

According to another example, the reflecting means includes a horn, the horn being configured to direct reflected radiation back onto the source. In yet a further example, the horn can be of any shape and can extend from one or more wire array/s as required.

In yet another embodiment, the source includes any one or a combination of: uranium; granite and americium. However, it needs to be appreciated that the source can be any matter which emits radiation such as that from historical nuclear test sites, hospital waste, nuclear power plant waste, radioactive water, and the like.

In yet another aspect, there is provided herein an apparatus for treating radioactive emission from a radioactive material, the apparatus including at least one reflecting means adapted to be in proximity to the radioactive material for receipt of the radioactive emission and to at least in whole or partially, reflect received emission towards the radioactive material, thereby stabilising the radioactive material. According to one specific example, the radioactive material is consequentially stabilised in a time frame that is significantly less than the documented natural decay of numerous (twenty or more ˜>2⁻²⁰) half-lives.

In yet another aspect, there is provided herein a method of treating a source of radioactive emission, the method including disposing/placing/providing at least one reflecting means in proximity to the source, the reflecting means being configured to receive the radioactive emission and to at least partially reflect received emission towards the source, thereby effecting reduction of the radioactive emission from the source.

It will be appreciated that any combination of the features described above or herein is possible and is not limited to the examples provided herein.

### BRIEF DESCRIPTION OF THE DRAWINGS

The invention may be better understood from the following non-limiting description of a preferred embodiment, in which:

FIG. 1 is a perspective view of an example apparatus for treating a source of radioactive emission;

FIG. 2 is a perspective view of an example apparatus for treating a source of radioactive emission, the apparatus being provided in a container;

FIG. 3 is a front view of an example apparatus for treating a source of radioactive emission;

FIG. 4 is a back view of an example apparatus for treating a source of radioactive emission;

FIG. 5 is a front view another example of an apparatus for treating a source of radioactive emission;

FIG. 6 is a side view of another example apparatus for treating a source of radioactive emission;

FIG. 7 is a reverse view of the example apparatus of FIG. 6;

FIGS. 8A to 8D show side views of examples of horns which can be used with the apparatus treating a source of radioactive emission;

FIGS. 9A and 9B are graphical representation of examples showing the effect of the apparatus and method described herein for treating a source of radioactive emission;

FIG. 10 is a photograph of an example container for holding an apparatus for treating a source of radioactive emission;

FIG. 11 is a photograph of the example container of FIG. 10, showing the covers closed and the lid of the container open;

FIG. 12 is a photograph of an example apparatus for treating a source of radioactive emission, placed in the container of FIG. 10;

FIG. 13 is a photograph of the example container of FIG. 10, with the covers closed and the cavity for holding the source from which radiation is emitted, open;

FIG. 14 is a photograph of another embodiment of an apparatus for treating a source of radioactive emission;

FIG. 15 is a photograph of another embodiment of an apparatus for treating a source of radioactive emission, showing one type of wire wrapped around another type of wire;

FIG. 16 is a photograph of another embodiment of an apparatus for treating a source of radioactive emission;

FIG. 17 is a photograph of another embodiment of an apparatus for treating a source of radioactive emission; and,

FIG. 18 is a photograph of another embodiment of an apparatus for treating a source of radioactive emission.

### DETAILED DESCRIPTION

An example of an apparatus for treating radiation emission is shown in FIG. 1. In particular, FIG. 1 shows an example of an apparatus 10 for treating a source 15 of radioactive emission 20.

In this example, the apparatus 10 includes at least one reflecting means 25 adapted to be in proximity to the source 15 for receipt of the radioactive emission 20. The reflecting means 25 at least partially reflects the received emission 20 towards the source 15, thereby effecting reduction of the radioactive emission 20 from the source 15.

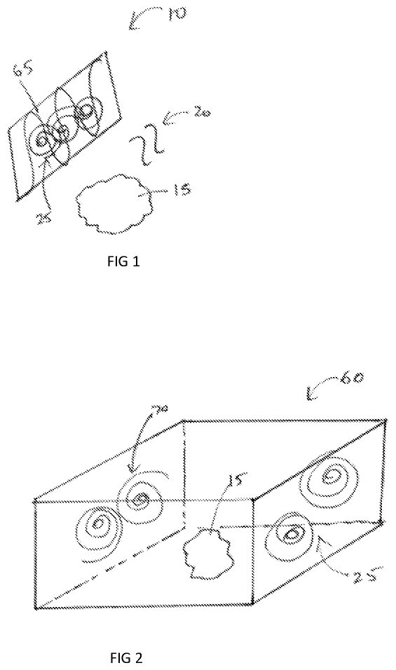

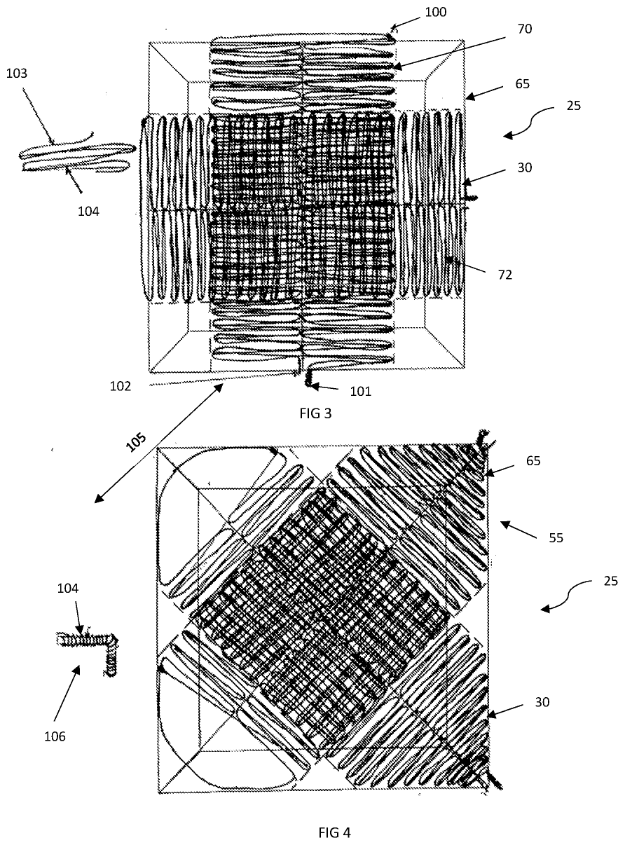

As shown in the FIGS. 1 to 4, and as further described below, the reflecting means 25 can include a wire array 30. According to one particular example, the wire array 30 can include a number of different formations. As further described herein, the wire array 30 can include at least a first and a second wire formation.

It will be appreciated by persons skilled in the art that the apparatus 10 can include a plurality or a number of reflecting means 25, including one or more wire arrays 30, which can be formed in a variety of patterns. In the examples shown, the wire array 30 includes a spiralled wire 45, formed in one or more circles 50. In yet a further example, the wire array 30 includes looped wire zig-zagged or serpentine formation 55. It will further be appreciated that the reflecting means 25 can include various combinations of the different wire formations described herein. Accordingly, the apparatus 10 can include a plurality of reflecting means 25, which can be arranged to at least partially surround the source 15. In one particular example, the plurality of reflecting means 25 is arranged within a container 60. In these examples, the container 60 is configured to hold the source 15 therein. In a further example, which is further described below, the container 60 can have lead shielding, which is configured to form a barrier between the radioactive source 50 and the outside of the container 60.

According to a further example, one or more reflecting means 25 can be mounted on a panel 65. Thus, the apparatus 10 can include a plurality of panels 65, which are then each placed internally around the sides of the container 60, and the source 15 is then placed in the middle of the container 60, such that the plurality of panels 65 then surround the source 15.

It will be appreciated by persons skilled in the art that the reflecting means 25 can include one or more wire formations, which can include one or more antennas. In this particular example, the or each antenna is configured to receive radiation and reflect radiation. As further discussed below, the antenna can include a horn 80, where the horn 80 is configured to direct reflected radiation back onto the source 15.

In yet a further example, it will be appreciated by persons skilled in the art that the source can include any one or a combination of uranium, graphite, or any material which emits radiation, including property, an area or volume affected by radiation and living creatures such as mammals.

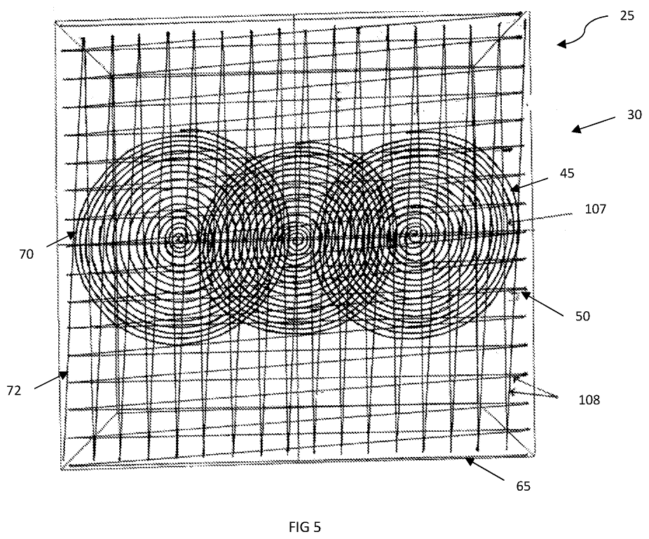

FIGS. 3 and 4 show an example of a reflecting means 25, for reflecting radioactive emissions. In this example, the wire array 30 includes a first type of wire formation 70 and a second type of wire formation 72, where the first and second wire formations 70 and 72, respectively, are attached to a panel 65 that holds the wire formations 70 and 72 in place. In this particular example, the wire formations 70 and 72 are formed by looping the wire in a zig-zagged, or serpentine formation across the panel 65 in opposite directions such that the first and second wire formations 70 and 72 are stacked on each other, where the second wire formation 72 is at a 90 degree right angle with respect to the first wire formation 70.

It will be appreciated by a person skilled in the art that the panel 65 can be any dimension. In the example shown in FIGS. 3 and 4 the panel 65 has a width (from left to right) of 370 mm, and a height (from top to bottom) of 370 mm. In FIG. 3, the wire formation 70, which runs from 100 to 101, with an input at 102, and in this example spans the height of the panel 65, typically has a width of 200 mm. FIG. 4 shows the example wiring which can be used includes a 2 mm steel wire 103 wound around with 0.75 mm copper wire at 104. Similarly, the width 105 of the formation of wires in FIG. 4 is 200 mm. FIG. 4 also shows an output terminal 106, with wound copper wire 104.

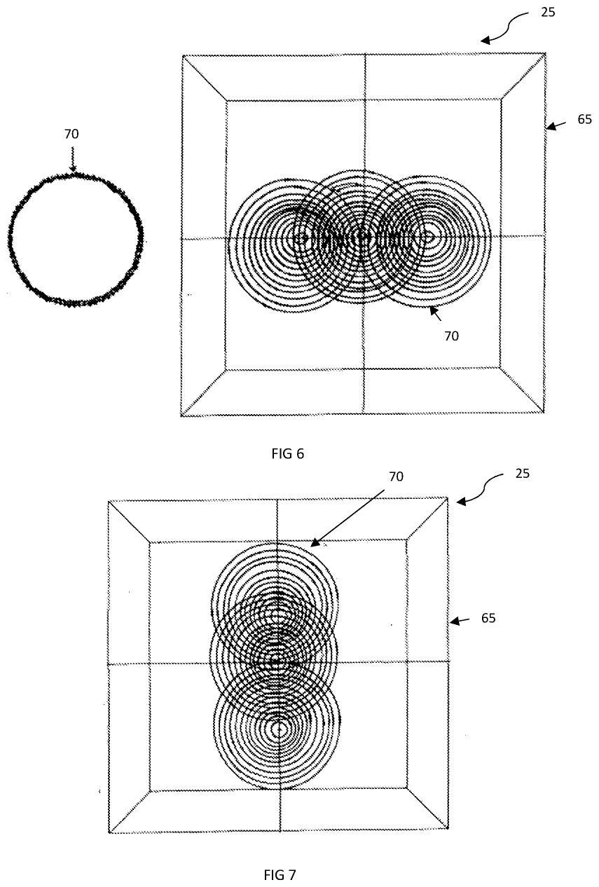

FIGS. 5 to 7 show further examples of a reflecting means 25, where the wire array 30 includes a first type of wire formation 70 and a second type of wire formation 72. In this particular example, the first type of wire formation 70 includes a plurality of spiralled wire, placed on the panel 65 such that they overlap with one another, transversely across the panel 65. The second type of wire formation 72 is then formed longitudinally across the spiralled first wire formation 70. This particular example of wire array 30 is further described below. Further, the first wire formation 70 is made from 17×3×2 mm steel wire 107 and the second wire formation 72 is formed of 17×2×0.75 mm enamelled copper wire 108.

Further, in the examples of FIGS. 6 and 7 show continuous copper coils, as the first type of wire formation 70, as opposed to one continuous spiral as shown in FIG. 5. In the examples of FIGS. 6 and 7, the continuous copper coils 70, are formed by concentric copper coils of different diameters. For example, the outer copper coil can have a diameter of 19 mm, then 17 mm, then 15 mm, etc., until the smallest diameter of 2 mm. In these examples, the wire can be copper wound core steel wire, of 2 mm thickness. Thus, a plurality of concentric formations are formed so that they are disposed at least partially covering one another, where in this specific example, the spanning width of the plurality of wire formations in the examples of FIGS. 6 and 7 is 38 cm.

It will be appreciated by persons skilled in the art that the examples shown in FIGS. 5-7 are neutron radiation interference targeting system, where the system of FIGS. 5-7 can assist in stabilising radiation. In particular, it will be appreciated by persons skilled in the art that the examples shown in FIGS. 5-7 are neutron, alpha, and beta radiation interference targeting systems. FIG. 5 shows an example of a configuration causing neutron radiation diminution, while FIGS. 6 and 7 illustrate alpha and beta particle interference arrays, varying in accordance with the plane of assembly—horizontal for alpha radiation, and vertical for beta radiation. It is thus provided that the system of FIGS. 5-7 can assist in stabilising neutron, alpha, and beta radiation.

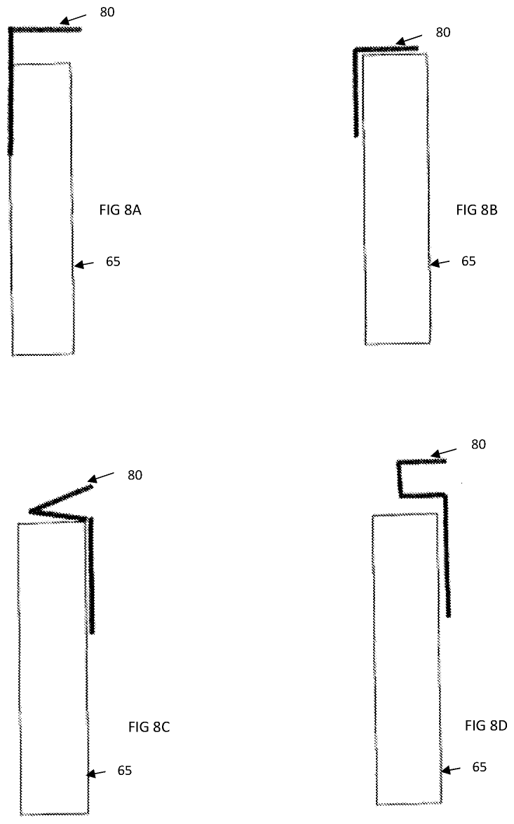

FIGS. 8A to 8D show example side profiles of horns 80 which can be formed extending from a wire array 30. Horns 80 are typically extended wire from the main wire array 30, which can assist in directing reflected radiation out of the wire array 30. In these particular examples, the horns are gamma (radiation component) output terminals. As shown in FIGS. 8A to 8D, many different shapes and positions of horns can be possible. For example, a horn 80 can extend from the panel 65 (or generally from a wire array 30), at a right angle from the back of the panel 65, positioned at or near a corner of the panel 65 (as shown in FIG. 8A). FIG. 8B shows a horn 80 extending at right angles where the top part 81 of the horn lies next to or flush with the panel 65. The horn 80 in this example is also formed at the back of the panel 65, positioned at or near a corner. FIG. 8C shows an example of a horn 80 extending from the panel in a v-shaped angled formation, extending from a central position of the front of the panel 65. Furthermore, FIG. 8D shows the horn 80 extending from the panel 65 in a c-shaped angled formation, again from a central position of the front face of the panel 65. Further specific examples of the apparatus and method described herein are provided below.

### Example 1

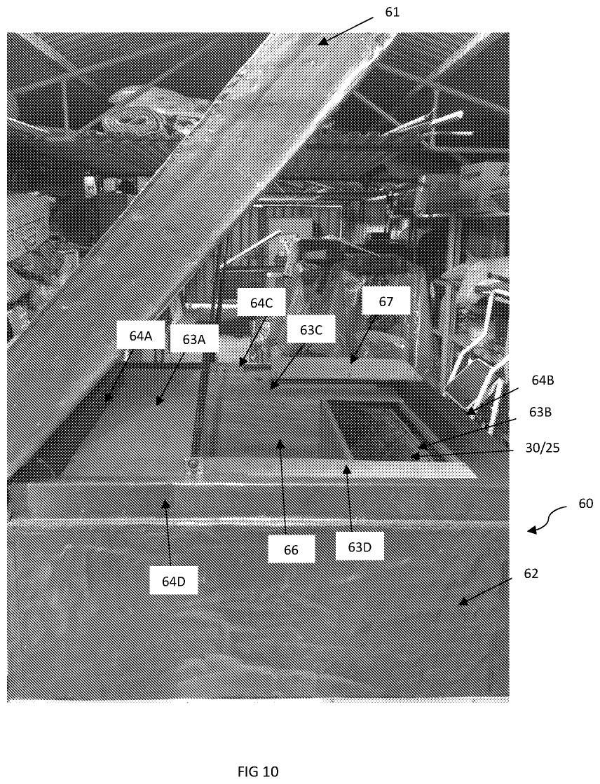

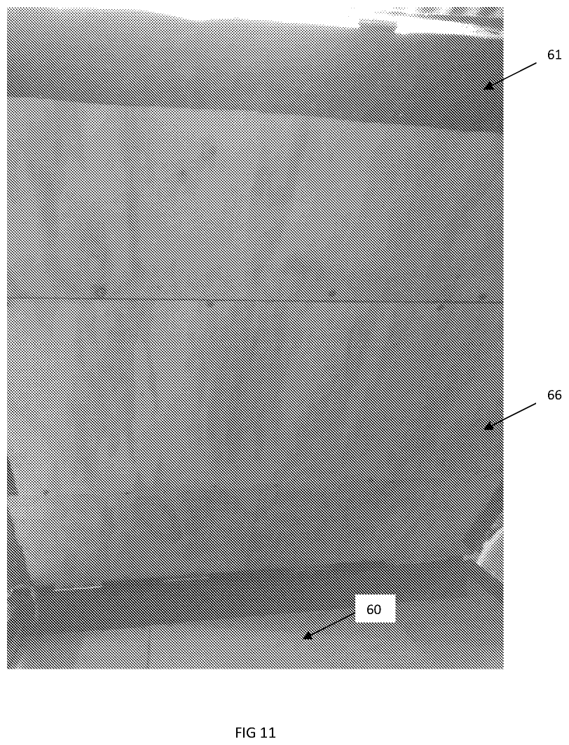

According to one specific example, the present method and apparatus was tested with a test sample of uranium ore, (which was placed in a container resembling a tea-chest (as shown in FIGS. 10 and 11 below). Other tests were also carried out, producing similar results irrespective of the starting ion emission count value.

In the aforementioned uranium ore example, the test sample was placed in the middle of the tea-chest sized cabinet, and was surrounded by a number of gamma radiation reflecting means on all sides of the body of the chest. The sample and the various reflecting means were then covered by one or more covers, and the lid of the chest was then closed. The chest was also covered in lead cladding, for occupational health and safety reasons, and to minimise any known external interference and internal radiation leaking to the outside. However, it will be appreciated that covering in lead is optional. In this example, a measuring device being a Geiger Counter was used to measure the ionising radiation being emitted. The measuring device used was an S.E. International Inc. Radiation Alert® Inspector, which is a handheld digital radiation survey meter.

Measurements were then taken by opening the ‘tea chest’ and reading the sample on a daily basis, once per day as close as possible to the same time of day.

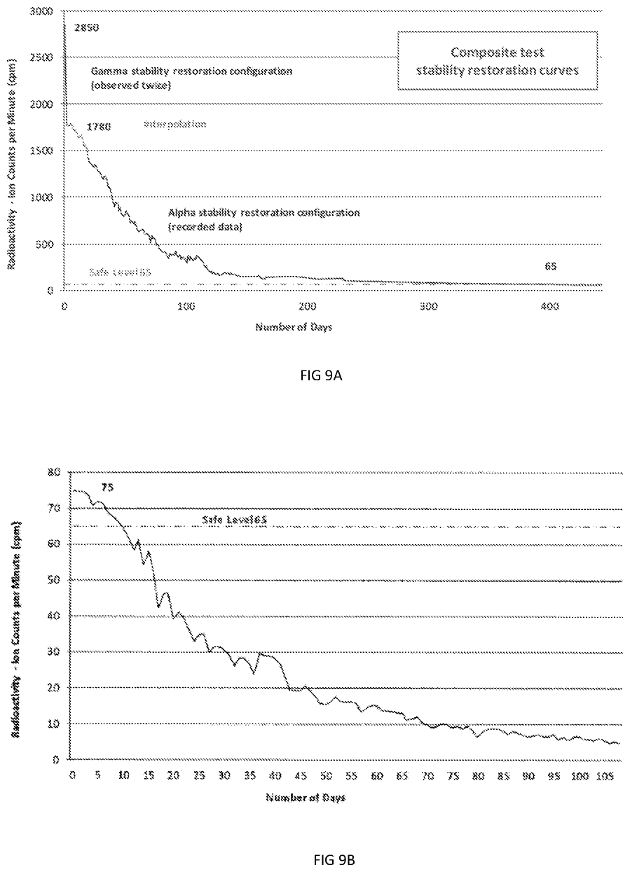

It was observed that the radioactive emission from the sample proceeded towards stability, as shown in FIG. 9A.

FIG. 9A shows that the ion counts per minute of the test sample significantly reduced from 2850 counts per minute to 65 counts per minute over 400 days.

### Example 2

Similarly to Example 1, above, further testing was conducted on granite as the source which emits radiation. The apparatus used was the same as that for Example 1.

The exposure of granite to the reflecting means reduced the radiation emitted from the granite. As shown in FIG. 9B, the counts per minute dropped from 77 to 0 over a period of 3 months.

Examples 1 & 2 are but a few examples of alpha beta gamma and neutron (or combinations thereof) as several other materials and tests were also carried out, however do not in any way materially affect the terms of this patent and should it be required, will at such time as necessary be the topic and discussion elsewhere if and as required.

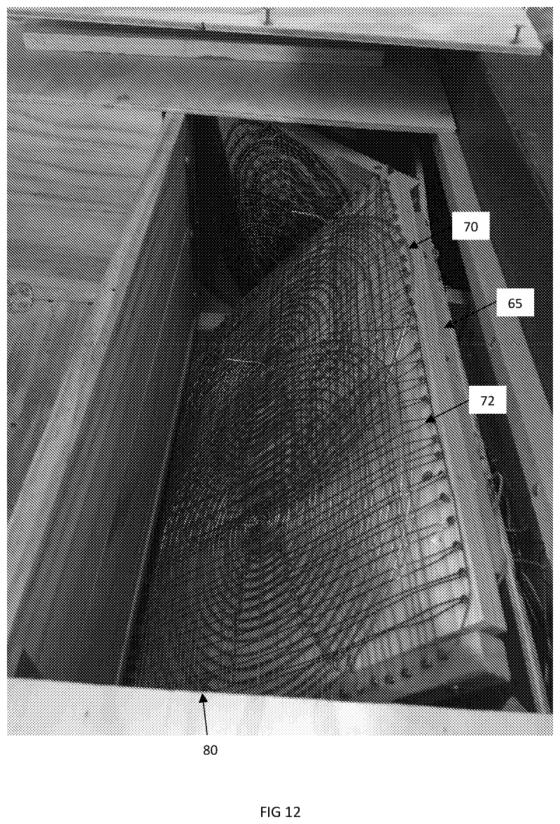

FIG. 10 is a photograph of the embodiment of a container 60, as used in the two specific examples described above. As can be seen in FIG. 10, the container 60 has a lid 61 and a body 62. The body 62 is divided into sections 63. In this particular example, as the container 60 has a square cross-section (i.e. is effectively a cube, or a rectangular prism), the sections include four side sections 63A, 63B, 63C, and 63D, which are surrounded by the sides 64A, 64B, 64C, and 64D of the container 60 respectively, thereby surrounding a middle portion (or centre cavity) 66 of the container 60. Each of the side sections 63A-63D is configured to receive one or more reflecting means 25. In this particular example, the reflecting means 25 includes a plurality of panels 65 with coiled wire arrays 30. Thus, each of the sections 63A-63D has a plurality of panels 65 therein, whereby the panels 65 are arranged to be either vertical or horizontal to each other. This is shown further in FIG. 12.

FIG. 10 also shows that each of the side sections 63A-64D are covered by a respective cover 66. In this particular example, the cover 66 is made from wood. In FIG. 10, one of the covers 67 is removed to show a side section 63. FIG. 10 further shows that the container 60 is clad with lead so as to protect any users from the hazardous radioactive material or source 15 which is typically placed inside the container 60.

FIG. 11 is a photograph of the container 60 showing the covers 66 in a closed position, when the lid 61 is in an open position.

FIG. 12 shows a plurality of panels 65, each with a wire array 30. This form of wire array 30 includes a continuous spiral of a first type of wire formation 70. As can be seen on the panel 65, there are two first types of wire formations 70 in overlapping spirals. Disposed on top of the first type of wire formation 70 is a second type of wire formation 72. In this example, the second type of wire formation is strapped across the first type of wire formation 70 in a number of vertical, horizontal, and diagonal strips. In this example, the first type of wire is made from galvanised fencing wire (typically but not necessarily) 12 gauge steel and can include many other dimensions as required.

According to one particular example, one or more horns 80 can be provided extending from the first type of wire formation 70. In the example shown in FIG. 12, the horns are formed in the middle of the spiral of the first type of wire formation 70. The horns 80 can assist in projecting the reflected radiation to the centre cavity/middle portion 66, where the source 15 is typically placed. It is hypothesised that the spiral portion of the first type of wire formation 70 can effectively work as an antenna which receives the radiation emitted by the source 15, and the horn 80 is configured to reflect the radiation back.

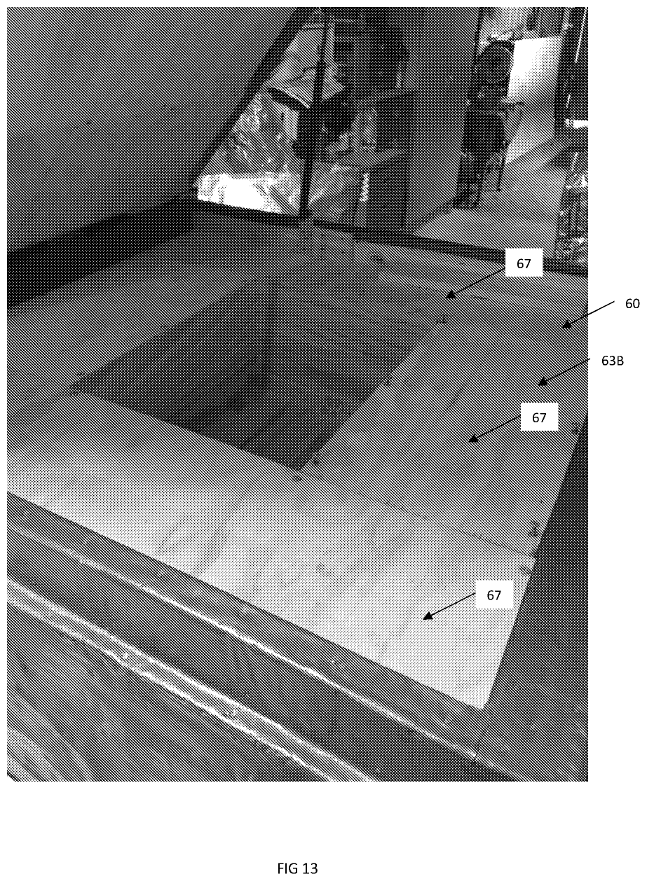

FIG. 13 shows another example of the container 60 with the cover 67 now covering the side section 64B, with the reflecting means 25 placed therein (as shown in FIG. 12). In this example, the middle portion 66 is empty but in use source 15 will be placed in the middle portion 66.

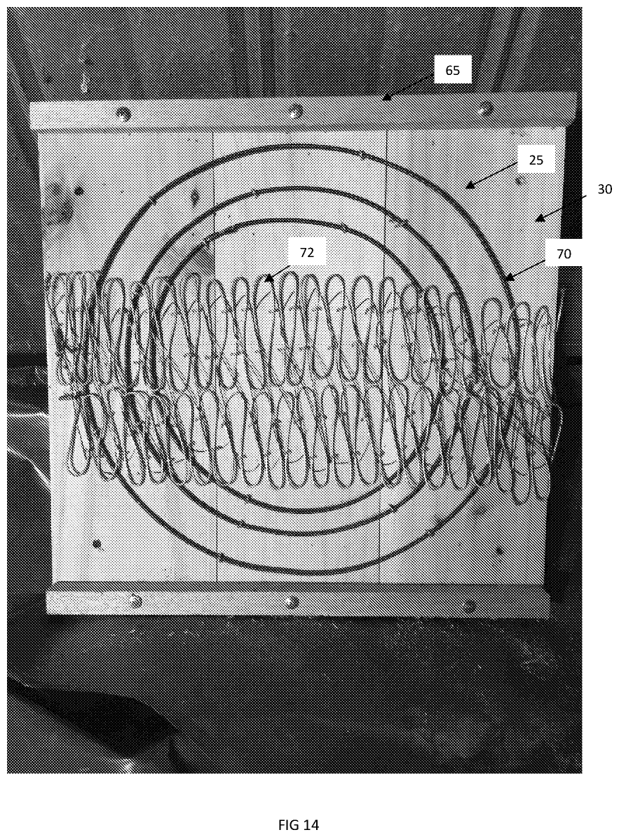

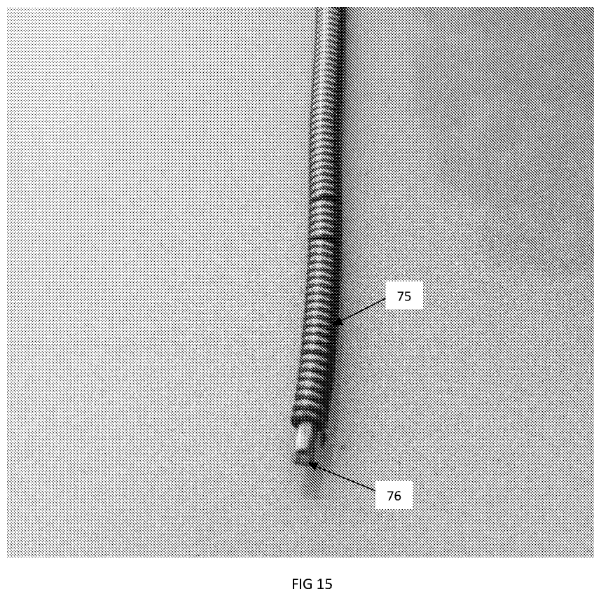

FIG. 14 shows another example of another type of reflecting means 25. In this example, the wire array 30 is formed such that the first type of wire formation 70 includes a number of concentric loops disposed on a panel 65. The formation of the concentric loops are further described below in relation to FIG. 15. In this example of FIG. 14, the second type of wire 72 includes a plurality of wires looped in a zig-zagged or serpentine formation, longitudinally along the panel 65.

It is hypothesised that in this type of structure, one of the wire arrays (such as the first type of wire formation 70) works to reflect back alpha and beta particles of radiation, whereas the second type of wire formation 72 works to reflect gamma radiation. It is further hypothesised that it is the two wire types of wire formations working together that effect decrease in radioactivity and (and hence increase in stability of the source), as shown in FIG. 9A.

FIG. 15 shows an example of a wire for the first type of wire formation 70. The wire in this example includes one type of metallic material 75 wrapped around a second type of metallic material 76. In this example, the second type of metallic material 76 is a galvanised metal wire, such as galvanised steel, and the second type of metallic material 75 is at least one coil of copper wire.

It is hypothesised that as these two types of metallic material effectively acting as an antenna are directionally placed at 90 degrees to each other, they enhance stabilisation of radiation from the source 15. Additionally, it is hypothesised that the reflecting means 25 is able to change unstable clockwise movement of atomic matter into stable anticlockwise movement. That is, the antenna receives atomic matter having anti-clockwise movement and reflects it so as to have clockwise movement, thus forcing the atomic matter to stabilise.

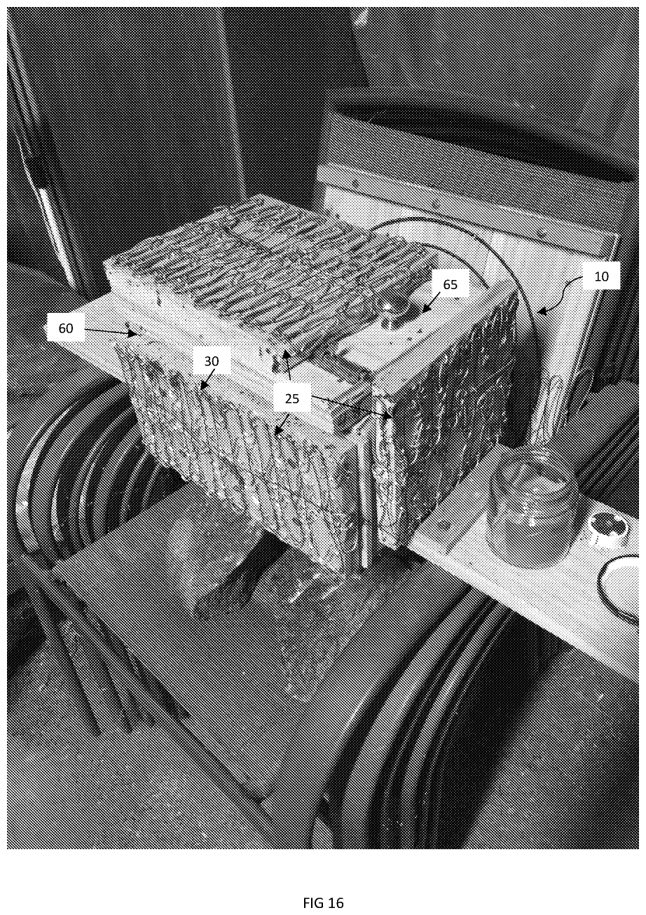

FIG. 16 shows another example of a container 60, where the reflecting means 25 is placed on the outside of the container 60, on each side of the container 60. In this particular example, the apparatus 10 as shown in FIG. 16 can be used to affect radiation emitted by forming an electromagnetic fog around the container 60. The wire array 30 in this particular example is wound so that it is zig-sagged, helical, or serpentine across a panel 65.

It will be appreciated that there can be a number of panels 65 with reflecting means 25 disposed around, and in proximity to the source 15. The placement of the panels 65 can be such that there are a plurality of panels 65 on either side of the source 15. The panels 65 can be overlapping, and/or placed in various directions to each other.

Further to this, it will also be appreciated that on each panel 65 there can be a variety of different shaped reflecting means 25, not limited to the examples described herein. That is, the wire arrays 30 on each panel 65 can be of a different form and it is not necessary that all the panels 65 be identical, nor the wire arrays 30.

It will also be appreciated that the examples shown herein are examples of a container 60 only and that many other devices or forms of surrounding the source with reflecting means 25 may be possible.

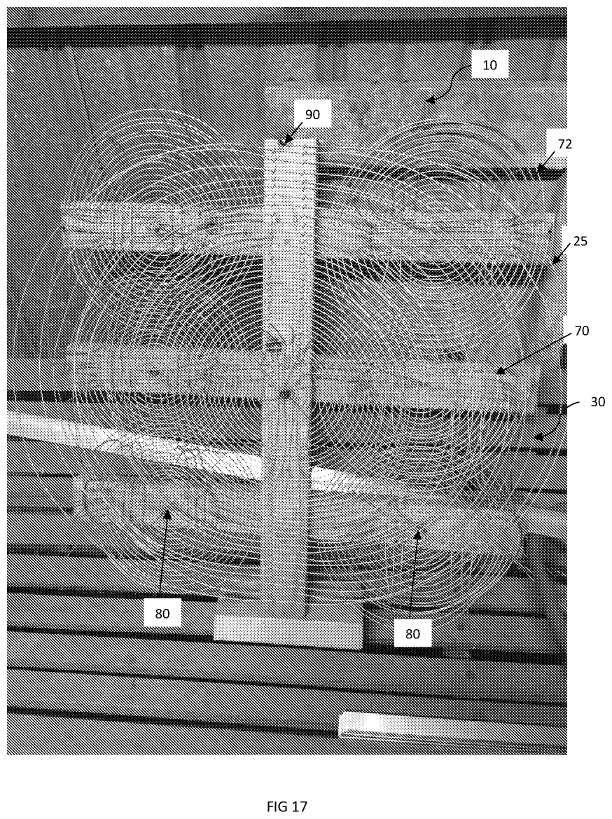

FIG. 17 shows another example of a reflecting means 25, mounted on a cross pole 90. In this example, the reflecting means 25 includes a wire array 30 which includes a plurality of first wire formation 70 being spiralled wire which are effectively formed so that they each cross-over one another, and a second wire formation 72 which is a larger spiral that is formed to cross-over the plurality of first wire formations 70. In this example, the plurality of first wire formation 70 include six decreasing antennas and the second wire formation 72 is a larger overlying antenna placed on top of the six decreasing antennas so as to substantially cover the surface area created by the six decreasing antennas 70. The smaller antennas 70 also include horns 80 in the middle of each spiral. In this particular example, the spiralled wire is steel, however, it will be appreciated that the present apparatus is not limited to the use of steel.

It will be appreciated that the example shown in FIG. 17 can not only diffuse radioactive emissions but may also work to cause a syncretic field of electromagnetic fog around a particular zone to exist. Thus for example, the example shown in FIG. 17 may also be used to not only target or convergence a radiation source in and around property or an area affected by radiation but may be inverted and act in a divergent manner in a greater syncretic field.

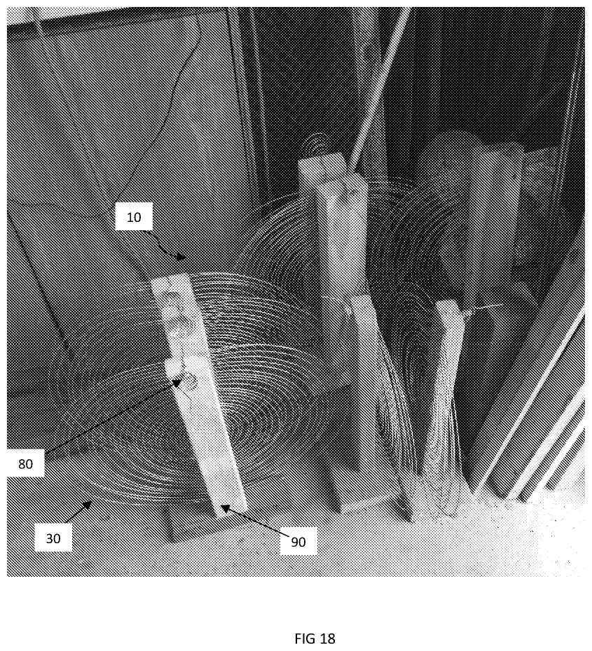

FIG. 18 shows a further example of an apparatus 10, whereby the horns 80 of each of the spiralled antennas are formed at the top of a pole 91 which the antenna is connected to. In this particular example, the antennas can also create an electromagnetic fog, and although a plurality of arrays 30 are shown, it may be possible to use only one for a particular application, although it is also possible to use a number of them at any one time.

It has been found that the present apparatus and method can reduce or even can negate ionising radiation, thereby stabilising radioactive material. In particular, it is believed that the four-layer unicursal labyrinth antenna system, with the transverse copper overlay, such as the example shown in FIGS. 5 and 12, can attract and absorb gamma radiation via passive inputs and transmit modified radiation back towards emitting materials—at a variation frequency of 3-8 Hz. The resulting diffusion field can then generate an interference pattern, which can cause unstable ellipsoidal electron orbital patterns to revert to their original, more stable, spherical patterning.

It is further hypothesised that the overlapping concentric wire array system described herein can generate a Vescial Pisces Interference Pattern resulting in a re-stabilisation of proton baryonic core. Unstable baryonic cores can demonstrate opposite spin by comparison with the more stable, proton baryonic cores. In effect, this system recovers the memory component of the proton structure, re-establishing coherence. Accordingly, it is hypothesised that this affects alpha particle radiation—especially if used with three or more layers×12 concentric steel 2 mm wire cores wound with 0.75 mm ceramic coated copper wire spiral with a 50% overlap.

It is also hypothesised that beta particle radiation can be affected with 3 layer×12 concentric steel 2 mm wire core with 0.75 mm ceramic coated copper wire spiral with 50% overlap, and a further alignment at 90 degrees to alpha particle componentry. The beta particles exhibit opposite spin to stable electrons due to weak meson core bonding. Being particulate in character, they also respond to re-patterning as occurs in alpha particle component effect.

In yet a further hypotheses, neutron radiation can be affected by three overlapping (by 50%) 2 mm steel wire spirals generating interference pattern overlaid by transverse copper grid generating a second interference pattern. It is hypothesised that neutron binary baryonic core has 4 bonds binding the neutron together, while unstable neutrons have only 2 bonds per baryon pair. Stable neutrons also exhibit anticlockwise spin whilst unstable neutrons have negligible or no spin component. This dual interference pattern resets the stable neutron pattern.

It will be appreciated that the method and apparatus discussed herein can be used in or as a part of a nuclear fuel cycle radioactive waste treatment system, including and not limited to nuclear waste contamination remediation industries, and the like.

It will be further appreciated that the method and apparatus discussed herein can be implemented in relatively quick time frames and inexpensive manner.

Further, the method and apparatus discussed herein can be used on any type or form of radiation source including radioactive material used in nuclear energy or power stations, in medical applications, research and development, mining applications, as well as military and weapon manufacturing and decommissioning industries. The method and apparatus discussed herein can also be applied to contaminated sites such as bodies of water, holding repositories of heavy water, both large and small buildings, and the like.

It may also be possible to use the method and apparatus discussed herein on animals, including humans who have been exposed to radiation, to assist in stabilising the radiation being emitted. For example, the method and apparatus described herein can assist in accelerating recovery from exposure to radioactive sources caused by medical radiation treatments such as X-rays, and dyes, or caused by ingestion or inhalation of, or contact with radioactive dusts, liquids, or gases from contaminated radioactively hazardous areas such as depleted uranium explosion sites and nuclear accident sites. Treatment by the method and apparatus as described herein can restore stability of any residual radioactivity of radioactive solids, liquids, or gases on or within the body.

Further, it may also be possible that with effective treating of a radiation source, such as treatment of radiation waste that is buried, and thereby stabilising the waste, the waste which has been stabilised can be reused in future applications.

The method and apparatus described herein can be installed or retrofitted for the treatment of either dry waste or pooled waste at existing nuclear power reactors, research reactors and waste treatment and processing facilities, providing an integrated capability to quickly process spent fuels and waste avoiding the current ‘on-costs’ of handling, transport, packaging and long-term storage.

The method and apparatus described herein can be integrated into the construction of nuclear power reactors, research reactors and waste treatment and processing facilities.

Further, the system and method described herein can be used in large-scale radiation contamination such as those caused by the Chernobyl and Fukushima Daiichi that have caused significant adverse global impact through their catastrophic failures. Further use can include the treatment of any decommissioned nuclear facility.

Accordingly, the advantages which can be achieved by embodiments of the apparatus and method described herein include, however are not limited to:
The capability to potentially significantly minimise or completely eliminate existing radioactive waste stockpiles and treat new waste as it comes to the end of its economic useful life, thereby reducing the need, demand, commercial pressure and costs associated with long-term, expensive storage facilities, with the potential to free up land and environmental areas, which otherwise would have been required to be secured against public use and access;
The accelerated remediation of contaminated environments within a relatively short time frame;
The capability in both convergent and dispersive configurations to affect only ionising radioactivity, being otherwise inert and benign with no detrimental effects on the surrounding natural environment;
The ability to allow for the treatment of radioactive waste undisturbed in its existing standard packaging containers, which can reduce the risk of exposure from transfer activity. Thus, for example, the method and apparatus described herein can be used to treat radioactive waste in containers such as drums, dry containment canisters, and the like; and
Reduction of the current costs associated with the expanding stockpile of nuclear waste, including unplanned large-scale contamination sites which can take thousands of years of high ongoing operating costs associated with regulation, control, storage, high security, and administration, which are currently required to keep the danger of a nuclear site safe.

It will further be appreciated that although the present description has been made in relation to radiation, the present application may also have applications with respect to electromagnetic waves generally. Thus, the apparatus 10 may be able to reflect any type of electromagnetic wave and diffuse its effect on it's surrounding environment.

Those skilled in the art will appreciate that the invention described herein is susceptible to variations and modifications other than those specifically described. All such variations and modifications are to be considered within the scope and spirit of the present invention the nature of which is to be determined from the foregoing description.

It will be appreciated that any form of the word “comprising”, “comprises”, “comprised”, and the like, as used herein, is used in an inclusive manner and is not excluding or limiting in its nature or meaning.

1. Apparatus for treating a source of radioactive emission, the apparatus including at least one reflecting means adapted to be in proximity to the source for receipt of the radioactive emission and to at least partially reflect received emission towards the source, thereby effecting reduction of the radioactive emission from the source.

2. The apparatus of claim 1, wherein the reflecting means includes a wire array.

3. The apparatus of claim 2, wherein a wire of the wire array includes at least one coil of copper wire wrapped around a galvanised metal wire.

4. The apparatus of claim 3, wherein the galvanised metal wire is steel wire.

5. The apparatus of claim 2, wherein the wire array includes spiralled wire formed in circles.

6. The apparatus of claim 2, wherein the wire array includes looped wire formed in zig-zags or a serpentine formation.

7. The apparatus of claim 1, wherein the apparatus includes a plurality of reflecting means.

8. The apparatus of claim 7, wherein each of the plurality of reflecting means can include any one or a combination of:
a. wire arrays including looped wire formed in circles; and
b. wire arrays including looped wire formed in zig-zags.

9. The apparatus of claim 7, wherein the plurality of reflecting means is arranged to at least partially surround the source.

10. The apparatus of claim 7, wherein the plurality of reflecting means is arranged within a container, the container being configured to hold the source therein.

11. The apparatus of claim 1, wherein the container has lead shielding.

12. The apparatus of claim 1, wherein the reflecting means is mounted on a panel.

13. The apparatus of claim 12, wherein the plurality of reflecting means is arranged within a container, the container being configured to hold the source therein, wherein the apparatus includes a plurality of panels, each of a plurality of the panels being placed internally around sides of the container, the source being placed centrally in the container such that the plurality of panels surround the source.

14. The apparatus of claim 1, wherein the reflecting means includes but is not limited to an antenna, the antenna being configured to receive radiation and in it inverse, reflect radiation.

15. The apparatus of claim 14, wherein the reflecting means includes a horn, the horn being configured to direct reflected radiation back onto the source.

16. The apparatus of claim 1, wherein the source includes any one or a combination of:
a. Uranium, Neptunium, Plutonium, Americium, Thorium or any other elements related or unrelated in this spectrum of the Periodic Table of Elements;
b. various other official and unofficial sources of radiation acquired and
c. Granite and other naturally occurring low level radioactive materials, which are known to have raised health concerns with a rowing number of people.

17. Apparatus for treating radioactive emission from a radioactive material, the apparatus including at least one reflecting means adapted to be in proximity to the radioactive material for receipt of the radioactive emission and to at least partially reflect received emission towards the radioactive material, thereby stabilising the radioactive material.

18. A method of treating a source of radioactive emission, the method including disposing at least one reflecting means in proximity to the source, the reflecting means being configured to receive the radioactive emission and to at least partially reflect received emission towards the source, thereby effecting reduction of the radioactive emission from the source.
